(19) United States
(12) Patent Application Publication
(10) Pub. No.: US 2016/0232683 A1
(43) Pub. Date: Aug. 11, 2016

(54) APPARATUS AND METHOD FOR ANALYZING MOTION

(71) Applicant: ELECTRONICS AND TELECOMMUNICATIONS RESEARCH INSTITUTE, Daejeon (KR)

(72) Inventors: Jong-Sung KIM, Daejeon (KR); Myung-Gyu KIM, Daejeon (KR); Ye-Jin KIM, Daejeon (KR); Seong-Min BAEK, Daejeon (KR); Sang-Woo SEO, Daejeon (KR); Il-Kwon JEONG, Daejeon (KR)

(21) Appl. No.: 14/997,743

(22) Filed: Jan. 18, 2016

(30) Foreign Application Priority Data
Feb. 9, 2015 (KR) 10-2015-0019327

(51) Int. Cl. G06T 7/20; H04N 13/02; G06T 7/00; H04N 13/00

(52) U.S. Cl. CPC G06T 7/2046; H04N 13/0007; H04N 13/025; H04N 13/0257; G06T 7/0046; G06T 2207/10028; G06T 2207/30196

(57) ABSTRACT

An apparatus for analyzing a motion includes an imaging unit configured to generate a depth image and a stereo image, a ready posture recognition unit configured to transmit a ready posture recognition signal to the imaging unit, a human body model generation unit configured to generate an actual human body model.

### CROSS-REFERENCE TO RELATED APPLICATION

This application claims priority to and the benefit of Korean Patent Application No. 2015-0019327, filed on Feb. 9, 2015, the disclosure of which is incorporated herein by reference in its entirety.

### BACKGROUND

1. Field of the Invention

The present disclosure relates to a technology for analyzing a motion of a user, and more particularly, to a technology for capturing a motion of a user without a marker and generating a motion analysis image representing the captured motion.

2. Discussion of Related Art

Motion capture is a technology widely used in various fields, such as, broadcasting, film making, animation, games, education, medical, military, and also sports. In general, the motion capture is achieved by using a marker-based motion analysis apparatus in which a marker is attached to a joint of a user who wears a specific-purpose suit, the position of the marker is tracked according to a change in posture and motion, and then reversely the posture and motion of the user is captured.

However, with many limitations on the installation area and installation method, and inconveniences that a user wears a specific-purpose suit and a marker is attached to a joint of the user, the marker-based motion analysis apparatus is mainly used in the fields of movie and animation in which a posture and motion are captured at an indoor space, such as a studio, rather than on-site. However, in some fields, such as sports, requiring on-site analysis of a posture and motion, the use of the marker-based motion analysis apparatus is limited.

In the recent years, there has been active development on apparatus and method for marker-free motion analysis that can improve limitations on the installation and inconvenience in the use of the marker-based motion analysis apparatus, However, due to limitations of photographing speed, resolution and precision of a depth camera, the marker-free motion analysis apparatus is only used for an interface that does not require a precise analysis of a posture and motion, for example, motion recognition, rather than other fields that require a precise analysis on a fast motion, for example, sports.

### SUMMARY OF THE INVENTION

The present disclosure is directed to technology for an apparatus and a method for analyzing a motion capable of capturing a high-speed motion without using a marker and generating a motion analysis image representing the captured motion.

The technical objectives of the inventive concept are not limited to the above disclosure; other objectives may become apparent to those of ordinary skill in the art based on the following descriptions.

In accordance with one aspect of the present disclosure, there is provided an apparatus for analyzing a motion, the apparatus including an imaging unit, a ready posture recognition unit, a human body model generation unit, a motion tracking unit, and a motion synthesis unit. The imaging unit may be configured to generate a depth image and a stereo image. The ready posture recognition unit may be configured to transmit a ready posture recognition signal to the imaging unit if a similarity between an actual skeleton model of a user and a standard skeleton model of a ready posture and a similarity between an actual silhouette model of the user and a standard silhouette model of the ready posture are determined to be equal to or greater than a predetermined threshold value with reference to the depth image. The human body model generation unit may be configured to generate an actual human body model by combining an intensity model, a color model and a texture model of a base model region on the stereo image with an actual base model of the user. The motion tracking unit may be configured to estimate a position and a rotation value of a rigid body motion of the actual skeleton model that maximize a similarity between a standard human body model and the actual human body model through an optimization scheme. The motion synthesis unit may be configured to generate a motion analysis image by synthesizing a skeleton model corresponding to a rigid body motion with a stereo image or a predetermined virtual character image, wherein the imaging unit, upon receiving the ready posture recognition signal, may generate the stereo image.

The imaging unit may generate the depth image through a depth camera and generate the stereo image through two high-speed color cameras.

The ready posture recognition unit may calculate a similarity between the actual skeleton model and the standard skeleton model through Manhattan Distance and Euclidean Distance between the actual skeleton model and the standard skeleton model, and calculate a similarity between the actual silhouette model and the standard silhouette model through Hausdorff Distance between the actual silhouette model and the standard silhouette model.

The human body model generation unit may generate the actual base model in the form of a Sum of Un-normalized 3D Gaussians composed of a 3D Gaussian distribution model having an average of position and a standard deviation of position with respect to the actual skeleton model of the user.

The human body model generation unit may calculate the intensity model by applying a mean filter to an intensity value of the base model region, calculate the color model by applying a mean filter to a color value of the base model region, and calculate the texture model by applying a 2D Complex Gabor Filter to a texture value of the base model region.

In accordance with another aspect of the present disclosure, there is provided a method for analyzing a motion by a motion analysis apparatus, the method including: generating a depth image; generating a stereo image if a similarity between an actual skeleton model of a user and a standard skeleton model of a ready posture and a similarity between an actual silhouette model of the user and a standard silhouette model of the ready posture are determined to be equal to or greater than a predetermined threshold value with reference to the depth image; generating an actual human body model by combining an intensity model, a color model and a texture model of a base model region on the stereo image with an actual base model of the user; estimating a position and a rotation value of a rigid body motion of the actual skeleton model that maximize a similarity between a standard human body model and the actual human body model through an optimization scheme; and generating a motion analysis image by synthesizing a skeleton model corresponding to a rigid body motion with a stereo image or a predetermined virtual character image.

The generating of the depth image may include generating the depth image through a depth camera, and the generating of the stereo image may include generating the stereo image through two high-speed color cameras.

The generating of the stereo image if a similarity between an actual skeleton model of a user and a standard skeleton model of a ready posture and a similarity between an actual silhouette model of the user and a standard silhouette model of the ready posture are determined to be equal to or greater than a predetermined threshold value with reference to the depth image may include: calculating a similarity between the actual skeleton model and the standard skeleton model through Manhattan Distance and Euclidean Distance between the actual skeleton model and the standard skeleton model; and calculating a similarity between the actual silhouette model and the standard silhouette model through Hausdorff Distance between the actual silhouette model and the standard silhouette model.

The method may further include generating the actual base model in the form of a Sum of Un-normalized 3D Gaussians composed of a 3D Gaussian distribution model having an average of position and a standard deviation of position with respect to the actual skeleton model of the user.

The method may further include calculating the intensity model by applying a mean filter to an intensity value of the base model region, calculating the color model by applying a mean filter to a color value of the base model region, and calculating the texture model by applying a 2D Complex Gabor Filter to a texture value of the base model region.

As is apparent from the above, the apparatus and method for analyzing a motion according to an exemplary embodiment of the present disclosure can automatically track a bodily motion of a user without a need of a marker t by using a high-speed stereo RGB-D camera including a high-speed stereo color camera and a depth camera.

In addition, the apparatus and method for analyzing a motion according to an exemplary embodiment of the present disclosure can automatically perform a high-speed photography on a posture and motion of high-speed sports without a need of additional trigger equipment by recognizing a ready posture through comparison of a similarity between an actual skeleton model of a user analyzed through a depth image photographed by the depth camera and a standard skeleton model of a ready posture registered in a database and through measurement of a similarity between an actual silhouette model of the user analyzed through the depth image and a standard silhouette model of the ready posture registered in the database and by generating an initialization signal of the high-speed stereo color camera.

In addition, the apparatus and method for analyzing a motion according to an exemplary embodiment of the present disclosure can enable a user to automatically perform an on-site motion capture without a marker attached to the user, by achieving a human body motion tracking with continuous tracking of a human body motion by performing an actual body motion tracking by generating an actual human body model by combining a base model generated based on an actual skeleton model of the user analyzed through a depth image with an actual intensity model, a color model and a texture model analyzed through a stereo color image, and then by estimating an actual rigid body motion that maximizes a similarity between a standard human body model registered in the database and the actual human body model.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating an apparatus for analyzing a motion according to an exemplary embodiment of the present disclosure;

FIG. 2 is a drawing illustrating an actual skeleton model and a standard skeleton model used by an apparatus for analyzing a motion according to an exemplary embodiment of the present disclosure,

FIG. 3 is a drawing illustrating an actual silhouette model and a standard silhouette model used by an apparatus for analyzing a motion according to an exemplary embodiment of the present disclosure;

FIG. 4 is a drawing illustrating an actual base model generated by an apparatus for analyzing a motion according to an exemplary embodiment of the present disclosure;

FIG. 5 is a drawing illustrating a motion analysis image generated by an apparatus for analyzing a motion according to an exemplary embodiment of the present disclosure;

FIG. 6 is a flowchart showing a process of analyzing a motion of a user by an apparatus for analyzing a motion according to an exemplary embodiment of the present disclosure;

FIG. 7 is a drawing illustrating an example in which an apparatus for analyzing a motion according to an exemplary embodiment of the present disclosure is installed; and

FIG. 8 is a drawing illustrating an example of a computer system in which a motion analysis apparatus is implemented.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that when an element is referred to as “transmitting” a signal to another element, unless otherwise defined, it can be directly connected to the other element or intervening elements may be present.

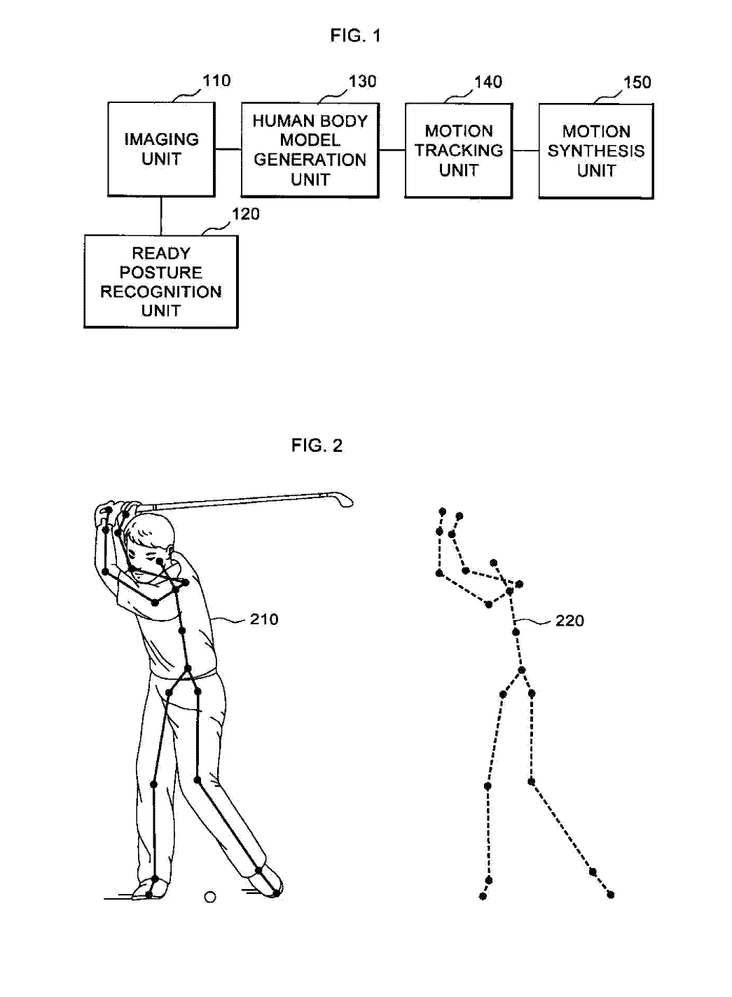

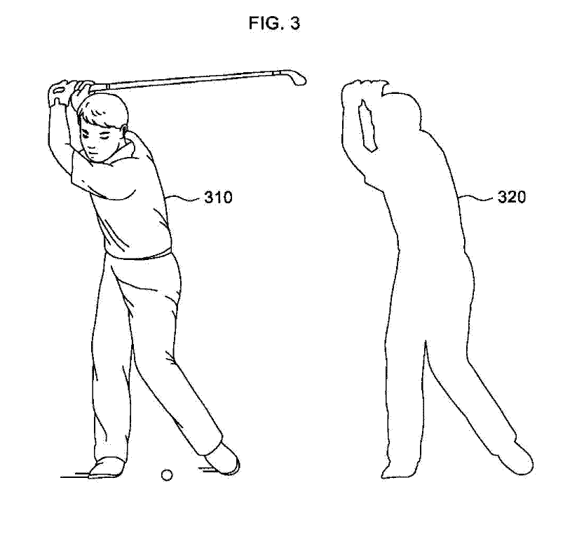

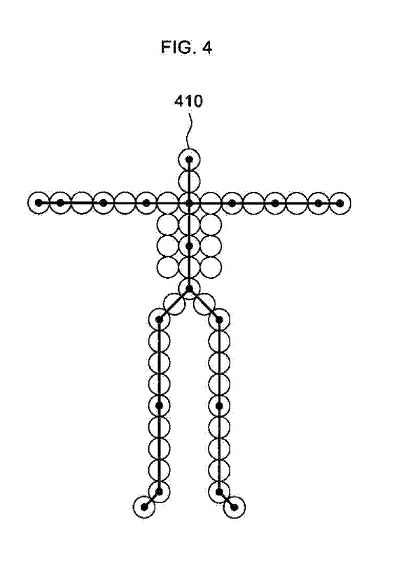

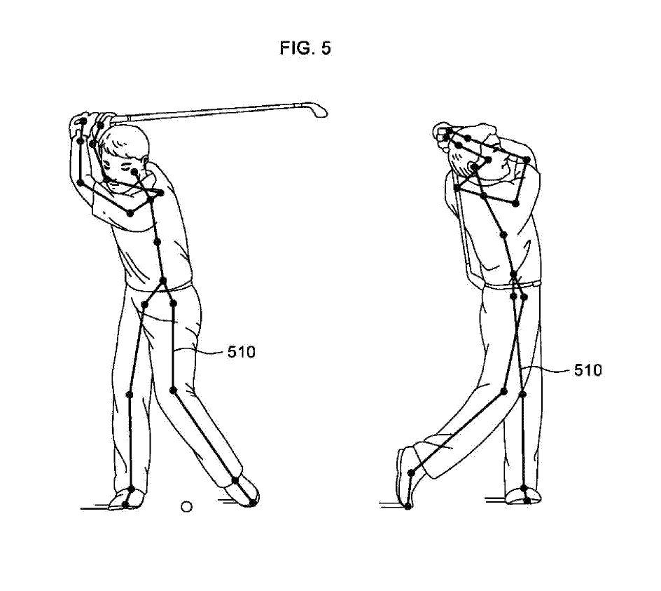

FIG. 1 is a block diagram illustrating an apparatus for analyzing a motion according to an exemplary embodiment of the present disclosure, FIG. 2 is a drawing illustrating an actual skeleton model and a standard skeleton model used by an apparatus for analyzing a motion according to an exemplary embodiment of the present disclosure, FIG. 3 is a drawing illustrating an actual silhouette model and a standard silhouette model used by an apparatus for analyzing a motion according to an exemplary embodiment of the present disclosure, FIG. 4 is a drawing illustrating an actual base model generated by an apparatus for analyzing a motion according to an exemplary embodiment of the present disclosure, and FIG. 5 is a drawing illustrating a motion analysis image generated by an apparatus for analyzing a motion according to an exemplary embodiment of the present disclosure.

Referring to FIG. 1, an apparatus for analyzing a motion according to an exemplary embodiment of the present disclosure includes an imaging unit 110, a ready posture recognition unit 120, a human body model generation unit 130, a motion tracking unit 140, and a motion synthesis unit 150.

The imaging unit 110 acquires a stereo image and a depth image through a high-speed stereo RGB-D camera including two high-speed color cameras and a single depth camera. First, the imaging unit 110 generates a depth image through the depth camera and transmits the generated depth image to the ready posture recognition unit 120. In this case, the imaging unit 110, upon receiving a ready posture recognition signal from the ready posture recognition unit 120, generates a stereo image through the high-speed color cameras and transmits the generated stereo image to the human body model generation unit 130.

The ready posture recognition unit 120 recognizes that a user is in a ready posture if a similarity between an actual skeleton model K_{c} (210 of FIG. 2) of the user analyzed from a depth image through a generally known depth image based posture extraction technology and a standard skeleton model Kᵣ (220 of FIG. 2) of the ready posture registered in a database and a similarity between an actual silhouette model S_{c} (310 of FIG. 3) of the user analyzed from the depth image and a standard silhouette model Sᵣ (320 of FIG. 3) of the ready posture registered in the database are equal to or greater than a predetermined threshold value, and transmits a ready posture recognition signal to the imaging unit 110.

The similarity between the actual skeleton model K_{c} 210 of the user and the standard skeleton model Kᵣ 220 of the ready posture may be calculated as L1 and L2 Norms respectively representing Manhattan Distance and Euclidean Distance between a relative 3D rotation Θ_{c} of an actual skeleton model and a relative rotation Θᵣ of a standard skeleton model as shown in Equation 1 below.

$${d}_{{L}_{1}} ( {Θ}_{c} , {Θ}_{r} ) = {\sum }_{n = 1}^{N} \vert {θ}_{c , n} - {θ}_{r , n} \vert \\ {d}_{{L}_{2}} ( {Θ}_{c} , {Θ}_{r} ) = \sqrt{{\sum }_{n = 1}^{N} {( {θ}_{c , n} - {θ}_{r , n} )}^{2 }} \qquad [ Equation 1 ]$$

In addition, the similarity between the actual silhouette model S_{c} 310 of the user and the standard silhouette model Sᵣ 320 of the ready posture may be calculated as Hausdorff Distance d_{H}(P_{c}, Pᵣ) between an image edge pixel P_{c} located at a position x on a 2D image of an actual silhouette model and an image edge pixel Pᵣ located at a position y on a 2D image of a standard silhouette model. In this case, the image edge pixel represents a pixel located on an outline of a silhouette model.

$${d}_{H} ( {P}_{c} , {P}_{r} ) = max ( {sup}_{x ∈ {E}_{c}} ( {inf}_{y ∈ {E}_{r}} {d}_{{L}_{2}} ( x , y ) ) , {sup}_{y ∈ {E}_{r}} ( {inf}_{x ∈ {E}_{c}} {d}_{{L}_{2}} ( y , x ) ) ) \qquad [ Equation 2 ]$$

E_{c} represents a set of image edge pixels P_{c} corresponding to an actual silhouette model and Eᵣ represents a set of image edge pixels Pᵣ corresponding to a standard silhouette model.

The human body model generation unit 130 generates an actual base model of a user according to the depth image, and generates a human body model of the user by using the base model and an intensity model, a color model and a texture model according to the stereo image.

For example, the human body model generation unit 130 may calculate an actual base model B_{c} (410 in FIG. 4) in the form of a Sum of Un-normalized 3D Gaussians (SOG) composed of a total of M 3D Gaussian distribution models having an average of position μ_{c} and a standard deviation of position σ_{c} with respect to an actual skeleton model of the user at a 3D spatial position X with reference to the depth image (M is a natural number equal to or larger than 1).

$${B}_{c} = {\sum }_{m = 1}^{M} {B}_{c , m} ( X ) = {\sum }_{m = 1}^{M} exp ( - \frac{{{d}_{{L}_{2 }} ( X , {μ}_{c , m} )}^{2}}{2 {σ}_{c , m}} ) \qquad [ Equation 3 ]$$

B_{c,m}(X) is a 3D Gaussian distribution having an average of position μ_{c} and a standard deviation of position σ_{c} with respect to an actual skeleton in a 3D spatial position X, and σ_{c,m} is a standard deviation of position of an m^{th} Gaussian distribution model, and μ_{c,m} is an average of position of an m^{th} Gaussian distribution model.

The human body model generation unit 130 generates an actual human body model by combining an intensity model I_{c}, a color model C_{c} and a texture model T_{c} of a region corresponding to an actual base model on the stereo image (hereinafter, referred to as a base model region) with the actual base model B_{c} of the user. In this case, an intensity value combined with the m^{th} Gaussian distribution model B_{c,m} is provided in a form including a single real number, a color value combined with the m^{th} Gaussian distribution model B_{c,m} is provided in a form including real numbers corresponding to R (red), G (green) and B (blue), respectively, and a texture value combined to the m^{th} Gaussian distribution model B_{c,m} is texture data provided as a vector having V real numbers that are calculated through V specific filters, and is defined as t_{c,m}=(t_{c,m,t}, . . . t_{c,m,V}). The human body model generation unit 130 may output an average intensity value calculated by applying a mean filter to an intensity value of the base model region as an intensity value i_{c,m}, and output an average color value calculated by applying a mean filter to color information about the base model region as a color value c_{c,m}. The human body model generation unit 130 may apply a 2D Complex Gabor Filter, which has a Gaussian Envelope with magnitude value A and rotation value φ, and a Complex Sinusoid with spatial frequency u₀, v₀, and phase difference φ, to the base model region.

f(x,y)=A exp(−π((x cos φ+y sin φ)²+(−x sin φ+y cos φ)²))exp(j(2π(u₀x+vₒy)+φ)) [Equation 4]

In addition, the human body model generation unit 130 may perform a non-linear transformation on a magnitude value of a result obtained by applying the 2D Complex Gabor Filter to the base model region according to Equation 4, thereby calculating a texture value t_{c,m} as shown in Equation 5 below.

t_{c,m}=(log(1+|f_{c,m,1}|), . . . log(1+|f_{c,m,y}|)) [Equation 5]

The motion tracking unit 140 calculates a similarity between a standard human body model Gᵣof a user registered in the user database and an actual human body model G_{c} generated with reference to the depth image and the stereo image as shown in Equation 6 below. In this case, the motion tracking unit 140 calculates a similarity E between a standard skeleton model Kᵣ, a standard base model Bᵣ, a standard intensity model Iᵣ, a standard color model Cᵣ, and a standard texture model Tᵣ and a skeleton model K_{c}, a base model B_{c}, an intensity model Iᵣ, a color model C_{c}, and a texture model T_{c} analyzed on the stereo image as shown in Equation 6 below.

$$\begin{matrix}E ( {G}_{r} , {G}_{c} ) = E ( {G}_{r} ( {K}_{r} , {B}_{r} , {I}_{r} , {C}_{r} , {T}_{r} ) , {G}_{r} ( {K}_{c} , {B}_{c} , {I}_{c} , {C}_{c} , {T}_{c} ) ) \\ = \int {\sum }_{s ∈ {K}_{r}} {\sum }_{d ∈ {K}_{c}} {d}_{{C}^{2}} ( {i}_{r , s} {i}_{c , d} ) {d}_{{C}^{2}} ( {c}_{r , s} , {c}_{c , d} ) {d}_{{C}^{2}} ( {t}_{r , s} , {t}_{c , d} ) \\ {B}_{r , s} ( x ) {B}_{c , s} ( x ) d x \\ = {\sum }_{s ∈ {K}_{r}} {\sum }_{d ∈ {K}_{c}} {E}_{s , d}\end{matrix} \qquad [ Equation 6 ]$$

A similarity E_{s,d} between an s^{th} standard human body model and a d^{th} human body model is defined as Equation 7, and a C² continuous distance d_{C2} is defined as Equation 8.

$$\begin{matrix}{E}_{s , d} = {d}_{{C}^{2}} ( {i}_{r , s} , {i}_{c , d} ) {d}_{{C}^{2}} ( {c}_{r , s} , {c}_{c , d} ) {d}_{{C}^{2}} ( {t}_{r , s} , {t}_{c , d} ) 2 π \frac{{σ}_{s}^{2} {σ}_{d}^{2}}{{σ}_{s}^{2} + {σ}_{d}^{2}} exp ( - \frac{{{d}_{{L}_{2}} ( {μ}_{s} , {μ}_{d} )}^{2}}{{σ}_{s}^{2} + {σ}_{d}^{2}} ) & [ Equation 7 ] \\ \{ \begin{matrix}{d}_{{C}^{2}} ( {i}_{r , s} , {i}_{c , d} ) = \{ \begin{matrix}0 & if ‖ {i}_{r , s} - {i}_{c , d} ‖ \geq {ɛ}_{sim , i} \\ {ϕ}_{3 , 1} & ( \frac{‖ {i}_{r , s} - {i}_{c , d} ‖}{{ɛ}_{sim , i}} )\end{matrix} \\ {d}_{{C}^{2}} ( {c}_{r , s} , {c}_{c , d} ) = \{ \begin{matrix}0 & if ‖ {c}_{r , s} - {c}_{c , d} ‖ \geq {ɛ}_{sim , c} \\ {ϕ}_{3 , 1} & ( \frac{‖ {c}_{r , s} - {c}_{c , d} ‖}{{ɛ}_{sim , c}} )\end{matrix} \\ {d}_{{C}^{2}} ( {t}_{r , s} , {t}_{c , d} ) = \{ \begin{matrix}0 & if ‖ {t}_{r , s} - {t}_{c , d} ‖ \geq {ɛ}_{sim , i} \\ {ϕ}_{3 , 1} & ( \frac{‖ {t}_{r , s} - {t}_{c , d} ‖}{{ɛ}_{sim , t}} )\end{matrix}\end{matrix} & [ Equation 8 ]\end{matrix}$$

φ_{3,1} is a C² continuous Smooth Wendland Radial Basis Function, which has a characteristic that φ_{3,1}(0)=1, φ_{3,1}(1)=0. In addition, ε_{sim,i}, ε_{sim,c}, ε_{sim,t} represent Maximum Distance Threshold Values of intensity, color and texture, respectively. When differences in intensity, color and texture are greater than the Maximum Distance Threshold Values, the similarity is 0.

The motion tracking unit 140 performs a motion tracking by estimating a position value and a rotation value of a rigid body motion Ω_{c} of the actual skeleton model K_{c} that maximize the similarity E obtained through the above process through an optimization scheme. The motion tracking unit 140 repeatedly performs the above process whenever a new stereo image is input. The motion tracking unit 140 sets rigid body motions Ωc,₁ to Ωc,t (t is a natural number equal to or greater than 2) that are consecutively estimated through the above process as motions corresponding to skeleton models Kc,₁ to Kc,t.

The motion synthesis unit 150 generates a motion analysis image by synthesizing skeleton models Kc,₁ to Kc,t corresponding to the motions with a corresponding stereo image of the user or with a predetermined virtual character image. For example, the motion synthesis unit 150 generates a motion analysis image by synthesizing a skeleton model 510 corresponding to a user motion with a stereo image, so that a user may clearly identify his/her motion by checking the motion analysis image.

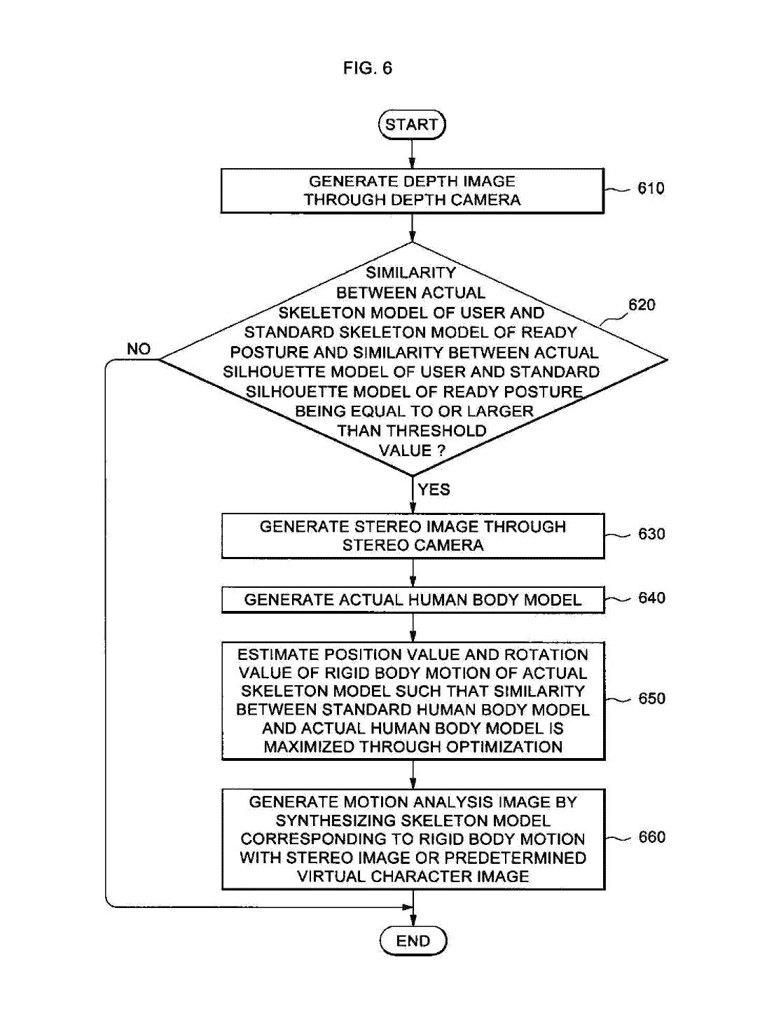

FIG. 6 is a flowchart showing a process of analyzing a motion of a user by an apparatus for analyzing a motion according to an exemplary embodiment of the present disclosure. In the following description, subjects performing respective operations are generally referred to as an apparatus for analyzing a motion, for brief and clear description of a process performed by a function part forming the motion analysis apparatus or for easy description of the present disclosure.

Referring to FIG. 6, the motion analysis apparatus generates a depth image through a depth camera (S610).

The motion analysis apparatus determines whether a similarity between an actual skeleton model of a user and a standard skeleton model of a ready posture and a similarity between an actual silhouette model of the user and a standard silhouette model of the ready posture are equal to or larger than a threshold value (S620).

If it is determined in operation S620 that a similarity between an actual skeleton model of a user and a standard skeleton model of a ready posture and a similarity between an actual silhouette model of the user and a standard silhouette model of the ready posture are equal to or larger than a threshold value, the motion analysis apparatus generates a stereo image through a stereo camera (S630).

The motion analysis apparatus generates an actual human body model by combining an intensity model I_{c}, a color model C_{c} and a texture model T_{c} of a region corresponding to an actual base model on the stereo image (hereinafter, referred to as a base model region) with the actual base model of the user B_{c} (S640).

The motion analysis apparatus estimates a position value and a rotation value of a rigid body motion of the actual skeleton model such that the similarity between the standard human body model and the actual human body model is maximized through an optimization scheme (S650).

The motion analysis apparatus generates a motion analysis image by synthesizing a skeleton model corresponding to a rigid body motion with a stereo image or a predetermined virtual character image (S660).

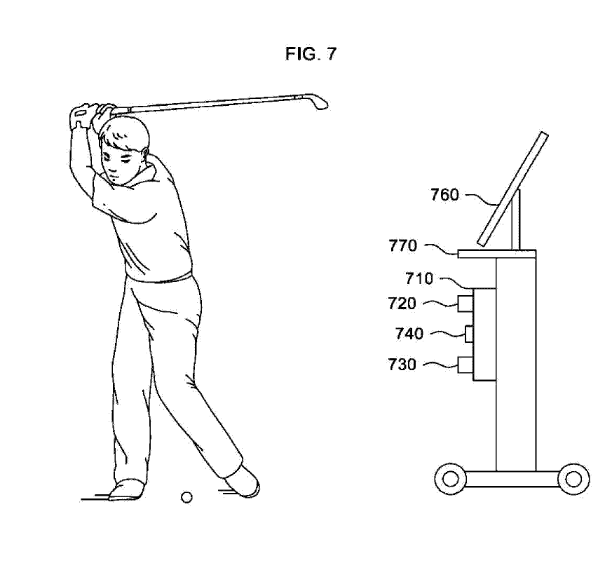

FIG. 7 is a drawing illustrating an example in which an apparatus for analyzing a motion according to an exemplary embodiment of the present disclosure is installed.

Referring to FIG. 7, the motion analysis apparatus may include a high-speed stereo RGB-D camera 710 composed of two high-speed cameras 720 and 730 and a depth camera 740, and an output device 760 to output a motion analysis image, for example, a monitor. In addition, the motion analysis apparatus may include an input unit 170 to control an operation of the motion analysis apparatus. Accordingly, the motion analysis apparatus may be provided as an integrated device, and may provide a motion analysis image by analyzing a motion of a user on-site, for example, outdoors.

The motion analysis apparatus according to an exemplary embodiment of the present disclosure may be implemented as a computer system.

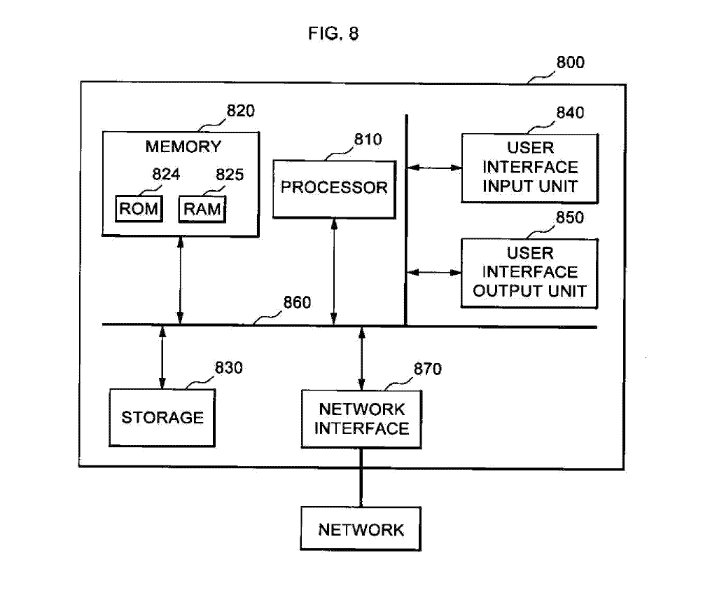

FIG. 8 is a drawing illustrating an example of a computer system in which a motion analysis apparatus according to an exemplary embodiment of the present disclosure is implemented.

The exemplary embodiment of the present disclosure may be implemented in a computer system, for example, as a computer-readable recording medium. Referring to FIG. 8, a computer system 800 may include at least one component among one or more processors 810, a memory 820, a storage 830, a user interface input unit 840 and a user interface output unit 850, the at least one component communicating with each other through a bus 860. In addition, the computer system 800 may include a network interface 870 to access a network. The processor 810 may be a central processing unit (CPU) or a semiconductor device configured to execute process instructions stored in the memory 820 and/or the storage 830. The memory 820 and the storage 830 may include various types of volatile/nonvolatile recording media. For example, the memory may include a read only memory (ROM) 824 and a random access memory (RAM) 825.

It will be apparent to those skilled in the art that various modifications can be made to the above-described exemplary embodiments of the present disclosure without departing from the spirit or scope of the invention. Thus, it is intended that the present disclosure covers all such modifications provided they come within the scope of the appended claims and their equivalents.

What is claimed is:

1. An apparatus for analyzing a motion, the apparatus comprising:
an imaging unit configured to generate a depth image and a stereo image;
a ready posture recognition unit configured to transmit a ready posture recognition signal to the imaging unit if a similarity between an actual skeleton model of a user and a standard skeleton model of a ready posture and a similarity between an actual silhouette model of the user and a standard silhouette model of a ready posture are determined to be equal to or greater than a predetermined threshold value with reference to the depth image;
a human body model generation unit configured to generate an actual human body model by combining an intensity model, a color model and a texture model of a base model region on the stereo image with an actual base model of the user;
a motion tracking unit configured to estimate a position and a rotation value of a rigid body motion of the actual skeleton model that maximizes a similarity between a standard human body model and the actual human body model through an optimization scheme; and
a motion synthesis unit configured to generate a motion analysis image by synthesizing a skeleton model corresponding to a rigid body motion with a stereo image or a predetermined virtual character image,
wherein the imaging unit, upon receiving the ready posture recognition signal, generates the stereo image.

2. The apparatus of claim 1, wherein the imaging unit generates the depth image through a depth camera and generates the stereo image through two high-speed color cameras.

3. The apparatus of claim 2, wherein the ready posture recognition unit calculates a similarity between the actual skeleton model and the standard skeleton model through Manhattan Distance and Euclidean Distance between the actual skeleton model and the standard skeleton model, and
calculates a similarity between the actual silhouette model and the standard silhouette model through Hausdorff Distance between the actual silhouette model and the standard silhouette model.

4. The apparatus of claim 1, wherein the human body model generation unit generates the actual base model in the form of a Sum of Un-normalized 3D Gaussians composed of a 3D Gaussian distribution model having an average of position and a standard deviation of position with respect to the actual skeleton model of the user.

5. The apparatus of claim 1, wherein the human body model generation unit calculates the intensity model by applying a mean filter to an intensity value of the base model region,
calculates the color model by applying a mean filter to a color value of the base model region, and
calculates the texture model by applying a 2D Complex Gabor Filter to a texture value of the base model region.

6. A method for analyzing a motion by a motion analysis apparatus, the method comprising:
generating a depth image;
generating a stereo image if a similarity between an actual skeleton model of a user and a standard skeleton model of a ready posture and a similarity between an actual silhouette model of the user and a standard silhouette model of the ready posture are determined to be equal to or greater than a predetermined threshold value with reference to the depth image;
generating an actual human body model by combining an intensity model, a color model and a texture model of a base model region on the stereo image with an actual base model of the user;
estimating a position and a rotation value of a rigid body motion of the actual skeleton model that maximize a similarity between a standard human body model and the actual human body model through an optimization scheme; and
generating a motion analysis image by synthesizing a skeleton model corresponding to a rigid body motion with a stereo image or a predetermined virtual character image.

7. The method of claim 5, wherein the generating of the depth image comprises generating the depth image through a depth camera, and
the generating of the stereo image comprises generating the stereo image through two high-speed color cameras.

8. The method of claim 7, wherein the generating of the stereo image if a similarity between an actual skeleton model of a user and a standard skeleton model of a ready posture and a similarity between an actual silhouette model of the user and a standard silhouette model of the ready posture are determined to be equal to or greater than a predetermined threshold value with reference to the depth image comprises:
calculating a similarity between the actual skeleton model and the standard skeleton model through Manhattan Distance and Euclidean Distance between the actual skeleton model and the standard skeleton model; and
calculating a similarity between the actual silhouette model and the standard silhouette model through Hausdorff Distance between the actual silhouette model and the standard silhouette model.

9. The method of claim 6, further comprising generating the actual base model in the form of a Sum of Un-normalized 3D Gaussians composed of a 3D Gaussian distribution model having an average of position and a standard deviation of position with respect to the actual skeleton model of the user.

10. The method of claim 6, further comprising calculating the intensity model by applying a mean filter to an intensity value of the base model region,
calculating the color model by applying a mean filter to a color value of the base model region, and
calculating the texture model by applying a 2D Complex Gabor Filter to a texture value of the base model region.
